(19) United States
(12) Patent Application Publication
(10) Pub. No.: US 2006/0289362 A1
(43) Pub. Date: Dec. 28, 2006

(54) Water treatment method and water treatment apparatus

(75) Inventors: Tokiko Yamauchi, Tokyo (JP); Nozomu Yasunaga, Tokyo (JP); Seiji Noda, Tokyo (JP); Seiji Furukawa, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Electric Corporation, Tokyo (JP)

(21) Appl. No.: 11/452,914

(22) Filed: Jun. 15, 2006

(30) Foreign Application Priority Data
Jun. 23, 2005 (JP) 2005-183673

(51) Int. Cl. C02F 1/68

(52) U.S. Cl. 210/749

(57) ABSTRACT

A water treatment method sufficiently decomposes low-degradable organic substances while suppressing production of bromate ions and consumption of hydrogen peroxide. A water treatment method for purifying water using radicals includes injecting an electron-donating substance selected from the group consisting of saccharides, amino acids, lipids, humic acid, and mixtures thereof into water. The radicals are preferably produced using ozone and hydrogen peroxide in combination. Further, the electron-donating substance is preferably injected into the water in a concentration of 0.1 μmol/L to 30 μmol/L.

### FIELD OF THE INVENTION

The present invention relates to a water treatment method and a water treatment apparatus each used for efficiently purifying water containing bromine ions.

### BACKGROUND OF THE INVENTION

Ozone treatment is a main process for advanced water purification treatment. Ozone is effective for sterilization, deodorization, and decoloring of water such as raw water. However, bromine ions in water are oxidized to produce bromate ions which may be carcinogenic. Two routes of production of bromate ions include: a production route (ozone route) employing bromine ions and ozone; and a production route (radical route) employing bromine ions and radical species such as hydroxyl radicals (.OH) which are produced through self-decomposition of ozone. In the ozone route, bromine ions (Br⁻) in water react with ozone to produce hypobromite ions (OBr⁻), and the hypobromite ions are oxidized by ozone to produce bromate ions (BrO₃⁻). In the radical route, bromate ions are produced by radicals and ozone. It is reported that the bromate ions are mainly produced through the radical route.

With the amendment of water quality standard for drinking water of 2004, bromate ions are regulated to 10 μg/L or less, and water purification plants have adopted various measures for suppressing production of bromate ions. Specific measures therefor include a control of ozone injection ratio and control of dissolved ozone concentration.

Recently, the presence of low-degradable organic substances which are hardly decomposed by ozone such as agricultural chemicals dissolved in water such as river water, lake water, or the like has become a problem, and decomposition and removal of the low-degradable organic substances require a high ozone injection ratio. A production of bromate ions increases with increasing ozone injection ratio, and thus it is difficult to decompose and remove the low-degradable organic substances through ozone treatment alone and suppress the production of the bromate ions at the same time. Thus, an attempt has been made in employing an advanced oxidation treatment technique for decomposing and removing the low-degradable organic substances by using radicals having higher oxidative power than ozone to water purification treatment (see JP 2003-1279 A, JP 2002-35775 A, and JP 2002-11485 A, for example). Those advanced oxidation treatment techniques are effective for decomposing and removing the low-degradable organic substances which are hardly decomposed by ozone, but may increase the production of bromate ions by the radicals. The low-degradable organic substances in river water or lake water are in low concentration, and trace amounts of radicals are required for decomposing and removing the low-degradable organic substances. However, excessive amounts of radicals for decomposing and removing the low-degradable organic substances are produced in a conventional advanced oxidation treatment technique, and the conventional advanced oxidation treatment technique has a problem of an increased production of bromate ions.

Thus, there is proposed as a measure for suppressing production of bromate ions a method of suppressing production of bromate ions by increasing a hydrogen peroxide injection ratio in an ozone/hydrogen peroxide treatment, which is one of the advanced oxidation treatment techniques (see JP 2002-514134 A, for example) However, it is reported that increase in the hydrogen peroxide injection ratio reduces a decomposition and removal ratio of the low-degradable organic substances. Further, this method has disadvantages in that the method involves increase in cost of chemicals and requires removal of excess hydrogen peroxide to increase cost. Thus, a treatment method for optimizing a radical reaction has been desired for the advanced oxidation treatment technique.

### SUMMARY OF THE INVENTION

Low-degradable organic substances in river water or lake water are in low concentration, and those organic substances can be decomposed and removed by trace amounts of radicals. However, excessive amounts of radicals for decomposing and removing the low-degradable organic substances are produced in a conventional advanced oxidation treatment technique, and the conventional advanced oxidation treatment technique has problems of an increased production of bromate ions by excess radicals and an increased consumption of hydrogen peroxide. Thus, if a state in which the radicals are produced in very low concentration can be maintained, a treatment time for sufficient decomposition and removal of the low-degradable organic substances can be assured, and the production of bromate ions and the consumption of hydrogen peroxide can be suppressed. That is, it is inevitable that a radical reaction be controlled for sufficiently decomposing the low-degradable organic substances while suppressing the production of bromate ions and the consumption of hydrogen peroxide.

Therefore, the inventors of the present invention have conducted extensive studies on a water treatment method for purifying water such as river water or lake water by using radicals. The inventors of the present invention have found that a specific electron-donating substance is injected into water to allow sufficient decomposition of low-degradable organic substances to a safe concentration range and to significantly reduce the production of bromate ions and the consumption of hydrogen peroxide. Thus, the inventors have completed the present invention.

That is, the present invention relates to a water treatment method for purifying water by using radicals, comprising injecting an electron-donating substance selected from the group consisting of saccharides, amino acid, lipid, humic acid and a mixture thereof into water.

In addition, the present invention relates to a water treatment apparatus for purifying water by using radicals, comprising an electron-donating substance injection means for injecting an electron-donating substance selected from the group consisting of saccharides, amino acid, lipid, humic acid and a mixture thereof into water.

According to the present invention, the radicals to be produced can be maintained at a very low concentration, and thus the low-degradable organic substances can be sufficiently decomposed while suppressing the production of bromate ions and the consumption of hydrogen peroxide.

### BRIEF DESCRIPTION OF THE DRAWINGS

In the accompanying drawings:

FIG. 1 is a flow chart for explaining a water treatment apparatus according to Embodiment 1 of the present invention;

FIG. 2 is a flow chart for explaining a water treatment apparatus according to Embodiment 2 of the present invention;

FIG. 3 a flow chart for explaining a water treatment apparatus according to Embodiment 3 of the present invention;

FIG. 4 is a diagram showing a change in geosmin concentration with respect to ozone injection rate in Example 1 and Comparative Example 1;

FIG. 5 is a diagram showing a change in bromate ion production with respect to ozone injection rate in Example 1 and Comparative Example 1;

FIG. 6 is a diagram showing a change in hydrogen peroxide concentration with respect to ozone injection rate in Example 1 and Comparative Example 1;

FIG. 7 is a diagram showing a change in bromate ion production at varying hydrogen peroxide injection rates;

FIG. 8 is a diagram showing a comparison of geosmin residual ratio at varying sucrose concentrations;

FIG. 9 is a diagram showing a comparison of bromate ion production at varying sucrose concentrations;

FIG. 10 is a diagram showing geosmin decomposition characteristics with respect to ozone injection rate in Example 2 and Comparative Example 2;

FIG. 11 is a diagram showing bromate ion production characteristics with respect to ozone injection rate in Example 2 and Comparative Example 2; and

FIG. 12 is a diagram showing a change in hydrogen peroxide concentration with respect to ozone injection rate in Example 2 and Comparative Example 2.

### DESCRIPTION OF THE PREFERRED EMBODIMENTS

Hereinafter, embodiments of the present invention will be described based on figures.

### Embodiment 1

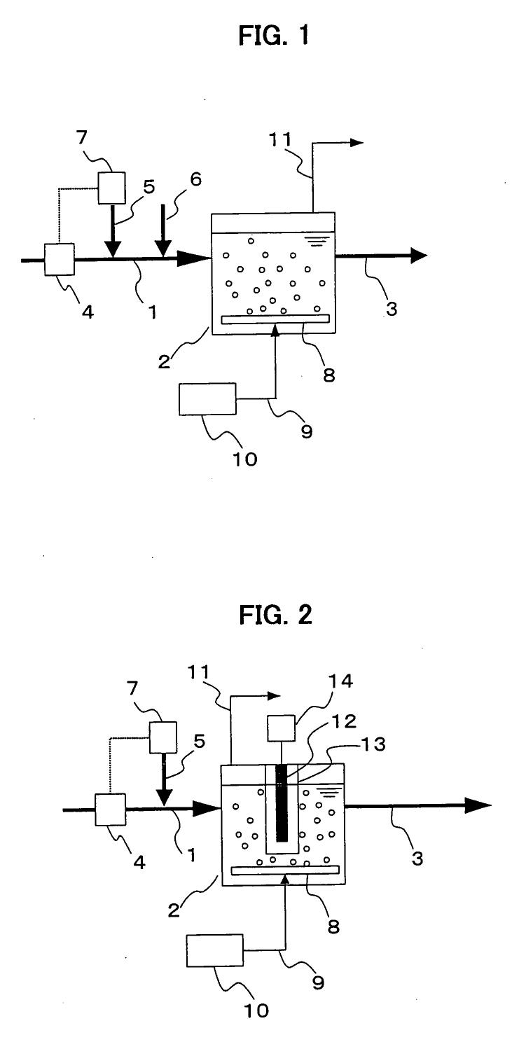

FIG. 1 is a flow chart for explaining a water treatment apparatus according to Embodiment 1 of the present invention.

In FIG. 1, a water treatment apparatus according to Embodiment 1 of the present invention is provided with a water inlet line 1, an ozone contact vessel 2 connected to a downstream side of the water inlet line 1, and a water discharge line 3 connected to the ozone contact vessel 2. A water quality meter 4 is arranged on an upstream side of the water inlet line 1, and an electron-donating substance injection line 5 as electron-donating substance injection means and a hydrogen peroxide injection line 6 are sequentially connected on a downstream side of the water quality meter 4. The water quality meter 4 is connected to the electron-donating substance injection line 5 through an electron-donating substance control device 7. An air diffuser plate 8 is arranged inside the ozone contact vessel 2, and an ozonizer 10 is connected to the air diffuser plate 8 through an ozone gas supply tube 9. Further, a waste ozone gas discharge tube 11 is connected in an upper part of the ozone contact vessel 2.

Next, a water treatment method performed by the water treatment apparatus constructed as described above will be described. First, water containing substances which produce bromate ions is introduced into the water inlet line 1. Then, an electron-donating substance is injected from the electron-donating substance injection line 5, and hydrogen peroxide is injected from the hydrogen peroxide injection line 6.

An injection rate of the electron-donating substance is adjusted by the electron-donating substance control device 7 in accordance with water quality of the water measured by the water quality meter 4. The injection rate of the electron-donating substance is preferably within a range in which a total organic carbon (TOC) concentration in the water does not exceed 5 mg/L, and the injection rate thereof is preferably 0.1 μmol/L to 30 μmol/L, more preferably 3 μmol/L to 30 μmol/L in the water. An injection rate of the electron-donating substance of less than 0.1 μmol/L may cause insufficient control of a radical reaction, and an injection rate thereof of more than 30 μmol/L may increase the TOC concentration in the water to increase the cost of TOC removal treatment. Further, an injection rate of hydrogen peroxide is preferably 0.05 to 5 mg/L.

The electron-donating substance to be used herein is an electron-donating substance selected from the group consisting of saccharides, amino acid, lipid, humic acid and a mixture thereof. Saccharides include, for example, glucose, fructose, galactose, mannose, maltose, sucrose, lactose, cellobiose, starch, cellulose, sodium alginate, chitin, and chitosan. Examples of amino acid include 20 kinds of amino acids consisting of tryptophan, leucine, lysine, isoleucine, valine, threonine, phenylalanine, methionine, histidine, arginine, cystine, tyrosine, alanine, asparaginic acid, glutamic acid, glycine, proline, serine, leucine, and threonine. Examples of lipid include, for example, lecithin, vitamin A, vitamin D, vitamin E, and vitamin K.

Next, the water containing the electron-donating substance and hydrogen peroxide injected is introduced into the ozone contact vessel 2. At the same time, an ozone gas generated by the ozonizer 10 flows through the ozone gas supply tube 9, is blown into the ozone contact vessel 2 from the air diffuser plate 8, and is dissolved in the water. An injection rate of the ozone gas is preferably 0.1 to 5.0 mg/L. As described above, hydrogen peroxide and ozone are used in combination to produce radicals. A decomposition reaction of low-degradable organic substances proceeds by the radicals. An undissolved ozone gas and an unreacted ozone gas are discharged to the outside of the vessel as a waste ozone gas through the waste ozone gas discharge tube 11. In Embodiment 1 of the present invention, the electron-donating substance is injected into the water, and thus a consumption of hydrogen peroxide and a production of bromate ions can be significantly reduced while maintaining a decomposition and removal effect of the low-degradable organic substance, to thereby provide highly safe treated water. Further, significant reduction in consumption of hydrogen peroxide allows suppression in injection rate of hydrogen peroxide, to thereby allow suppression in cost of chemicals and cost required for removing excess hydrogen peroxide.

Then, the water is retained in the ozone contact vessel 2 for a certain period of time and is discharged to the outside of the vessel through the water discharge line 3 as treated water containing no low-degradable organic substances to be decomposed and removed.

According to Embodiment 1 of the present invention, the electron-donating substance selected from the group consisting of saccharides, amino acid, lipid, humic acid and a mixture thereof is injected into the water. Thus, the radicals to be produced can be maintained at a very low concentration, and the low-degradable organic substances can be sufficiently decomposed while suppressing the production of bromate ions and the consumption of hydrogen peroxide. Meanwhile, in conventional ozone/hydrogen peroxide treatment, an absolute amount of OH radicals to be produced was suppressed by minimizing the injection rate of hydrogen peroxide. However, with the suppression in injection rate of hydrogen peroxide alone, OH radicals are instantaneously produced and consumed in a reaction and a treatment time for decomposing and removing the low-degradable organic substances to a safe concentration range cannot be assured. Further, reduction in residual concentration of hydrogen peroxide immediately produces bromate ions, and thus the suppression in injection rate of hydrogen peroxide may increase the production of bromate ions. That is, in the conventional ozone/hydrogen peroxide treatment, reduction in injection rate of hydrogen peroxide prevents sufficient decomposition of the low-degradable organic substances and prevents suppression in production of bromate ions.

In Embodiment 1 of the present invention, an injection order of the electron-donating substance and hydrogen peroxide into the water is not particularly limited. Hydrogen peroxide may be injected, and then the electron-donating substance may be injected. The electron-donating substance may be injected, and then hydrogen peroxide may be injected. Alternatively, hydrogen peroxide and the electron-donating substance may be injected at the same time. An injection position of the electron-donating substance is not limited to the water inlet line 1, and the electron-donating substance may be injected directly into the ozone contact vessel 2.

Embodiment 1 of the present invention employs the ozone/hydrogen peroxide treatment as a method of purifying water by using radicals. However, decomposition and removal of the low-degradable organic substances, reduction in consumption of hydrogen peroxide, and suppression in production of bromate ions may be attained at the same time through ozone/UV treatment, UV/hydrogen peroxide treatment, ozone/UV/hydrogen peroxide treatment, and the like. Further, in the present invention, an example of decomposition of the low-degradable organic substances was described, but the present invention may be applied to sterilization, deodorization, and decoloring of water.

### Embodiment 2

FIG. 2 is a flow chart for explaining a water treatment apparatus according to Embodiment 2 of the present invention.

In FIG. 2, a water treatment apparatus according to Embodiment 2 of the present invention is provided with a UV irradiation device constructed of: a UV lamp 12 arranged inside the ozone contact vessel 2, a UV lamp protecting tube 13 arranged inside the ozone contact vessel 2 so as to surround the UV lamp 12, and a UV lamp source 14 connected to the UV lamp 12 and arranged outside the ozone contact vessel 2. Other construction of the water treatment apparatus is the same as that shown in FIG. 1. Thus, in Embodiment 2, the same symbols represent the same parts as those of FIG. 1 and description of the same parts is omitted.

Next, a water treatment method performed by the water treatment apparatus constructed as described above will be described. First, water is introduced into the water inlet line 1. Then, the electron-donating substance is injected from the electron-donating substance injection line 5. The injection rate of the electron-donating substance is the same as that of Embodiment 1. Further, the electron-donating substance exemplified in Embodiment 1 may be used in the same manner.

Next, the water containing the electron-donating substance injected is introduced into the ozone contact vessel 2. At the same time, the ozone gas generated by the ozonizer 10 flows through the ozone gas supply tube 9, is blown into the ozone contact vessel 2 from the air diffuser plate 8, and is dissolved in the water. An undissolved ozone gas and an unreacted ozone gas are discharged to the outside of the vessel as a waste ozone gas through the waste ozone gas discharge tube 11. The injection rate of the ozone gas is preferably 0.1 to 5.0 mg/L. The ozone gas is dissolved in the water, and radicals are produced at the same time by irradiating the ozone gas with UV light from the UV irradiation device provided in the ozone contact vessel 2. A decomposition reaction of low-degradable organic substances proceeds by the radicals. In Embodiment 2 of the present invention, the electron-donating substance is injected into the water, and thus the production of bromate ions can be significantly reduced while maintaining a decomposition and removal effect of the low-degradable organic substance, to thereby provide highly safe treated water.

Then, the water is retained in the ozone contact vessel 2 for a certain period of time and is discharged to the outside of the vessel through the water discharge line 3 as treated water containing no low-degradable organic substances to be decomposed and removed.

According to Embodiment 2 of the present invention, the electron-donating substance is injected into the water in the ozone/UV treatment process. Thus, the radicals to be produced can be maintained at a very low concentration, and the low-degradable organic substances can be sufficiently decomposed while suppressing the production of bromate ions, to thereby provide highly safe treated water. Meanwhile, conventional ozone/UV treatment involves a treatment method in which ozone and radicals coexist, and has no specific measures for suppressing the production of bromate ions.

Note that in Embodiment 2 of the present invention, the number of UV lamps 12 provided inside the ozone contact vessel 2 is not particularly limited, and any number of UV lamps 12 may be provided as required.

### Embodiment 3

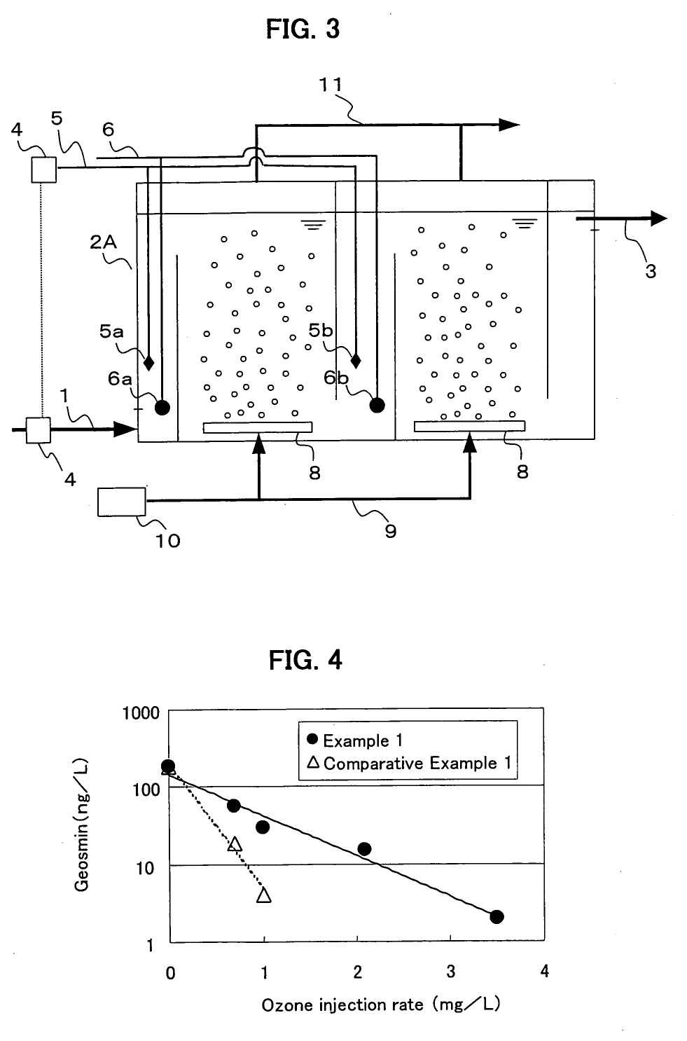

FIG. 3 is a flow chart for explaining a water treatment apparatus according to Embodiment 3 of the present invention. In Embodiment 3 of the present invention, a general transverse countercurrent two-stage ozone contact vessel for a large-scale water purification plant is used as the ozone contact vessel. In FIG. 3, a water treatment apparatus according to Embodiment 3 of the present invention is provided with a transverse countercurrent two-stage ozone contact vessel 2A, the water inlet line 1 connected to a first ozone contact vessel of the transverse countercurrent two-stage ozone contact vessel 2A, and the water discharge line 3 connected to a second ozone contact vessel of the transverse countercurrent two-stage ozone contact vessel 2A. The water quality meter 4 is arranged upstream of the water inlet line 1, and the water quality meter 4 is connected to the electron-donating substance injection line 5 through the electron-donating substance control device 7. The electron-donating substance injection line 5 branches into a first electron-donating substance injection line 5a and a second electron-donating substance injection line 5b which are arranged inside the first and second ozone contact vessels, respectively. Further, the hydrogen peroxide injection line 6 is branched into a first hydrogen peroxide injection line 6a and a second hydrogen peroxide injection line 6b which are arranged inside the first and second ozone contact vessels, respectively. The air diffuser plate 8 is arranged inside each of the first and second ozone contact vessels, and the ozonizer 10 is connected to the air diffuser plates 8 through the ozone gas supply tube 9. The waste ozone gas discharge tube 11 is connected to an upper part of the transverse countercurrent two-stage ozone contact vessel 2A.

Next, a water treatment method performed by the water treatment apparatus constructed as described above will be described. First, water is introduced into the transverse countercurrent two-stage ozone contact vessel 2A through the water inlet line 1. Then, the electron-donating substance is injected into the water from the first and second electron-donating substance injection lines 5a and 5b, and hydrogen peroxide is injected into the water from the first and second hydrogen peroxide injection lines 6a and 6b.

The injection rates of the electron-donating substance and of the hydrogen peroxide are the same as those of Embodiment 1. Further, the electron-donating substance exemplified in Embodiment 1 may be used in the same manner.

Next, an ozone gas generated by the ozonizer 10 flows through the ozone gas supply tube 9, is blown into the transverse countercurrent two-stage ozone contact vessel 2A from the air diffuser plates 8, and is dissolved in the water. An injection rate of the ozone gas is the same as that of Embodiment 1. As described above, hydrogen peroxide and ozone are used in combination to produce radicals. A decomposition reaction of low-degradable organic substances proceeds by the radicals in the same manner as in Embodiment 1. An undissolved ozone gas and an unreacted ozone gas are discharged to the outside of the vessel as a waste ozone gas through the waste ozone gas discharge tube 11.

Then, the water is retained in the transverse countercurrent two-stage ozone contact vessel 2A for a certain period of time and is discharged to the outside of the vessel through the water discharge line 3 as treated water containing no low-degradable organic substances to be decomposed and removed.

According to Embodiment 3 of the present invention, the electron-donating substance is injected into the water. Thus, the radicals to be produced can be maintained at a very low concentration, and the low-degradable organic substances can be sufficiently decomposed while suppressing the production of bromate ions and the consumption of hydrogen peroxide. Meanwhile, in conventional ozone/hydrogen peroxide treatment, an absolute amount of OH radicals to be produced was suppressed by minimizing the injection rate of hydrogen peroxide. However, with the suppression in injection rate of hydrogen peroxide alone, OH radicals are instantaneously produced and consumed in a reaction and a treatment time for decomposing and removing the low-degradable organic substances to a safe concentration range cannot be assured. Further, reduction in residual concentration of hydrogen peroxide immediately produces bromate ions, and thus the suppression in injection rate of hydrogen peroxide may increase the production of bromate ions. That is, in the conventional ozone/hydrogen peroxide treatment, reduction in injection rate of hydrogen peroxide prevents sufficient decomposition of the low-degradable organic substances and prevents suppression in production of bromate ions.

Note that in Embodiment 3 of the present invention, the injection order of the electron-donating substance and hydrogen peroxide into the water is not particularly limited. Hydrogen peroxide may be injected, and then the electron-donating substance may be injected. The electron-donating substance may be injected, and then hydrogen peroxide maybe injected. Alternatively, hydrogen peroxide and the electron-donating substance may be injected at the same time. The electron-donating substance only needs to be injected into the water by the time of radical treatment, and thus the injection position of the electron-donating substance is not limited to inside the transverse countercurrent two-stage ozone contact vessel 2A, and the electron-donating substance may be injected in advance from the water inlet line 1. Further, injection of the electron-donating substance and hydrogen peroxide may be performed at different positions at the same time or separately, or at one position. In the case where the ozone contact vessel 2 is a multi-stage vessel of n-vessels, n-injection positions of the electron-donating substance are desirably provided, and n-injection positions of hydrogen peroxide are desirably provided as well. In the case where n-injection lines of hydrogen peroxide and the electron-donating substance exist, the injection rates at all injection positions need not be equal, and the injection rates may be adjusted separately.

### EXAMPLES

### Example 1 and Comparative Example 1

An example of experimental results of ozone/hydrogen peroxide treatment of river water by using a water treatment apparatus having the same construction as that shown in FIG. 1 will be described. Table 1 shows experimental conditions. In Example 1, geosmin (odor material) was used as a model substance for a low-degradable organic substance, and 0.03 to 300 μmol/L of sucrose as an electron-donating substance was injected. In Comparative Example 1, geosmin (odor material) was used as a model substance for the low-degradable organic substance, and an electron-donating substance was not injected as in a conventional treatment method.

TABLE 1

| | | Comparative |
|---|---|---|
| | Example 1 | Example 1 |
| Ozone concentration (g/Nm³) | 5 | |
| Gas flow rate (L/min) | 0.25 | |
| Treatment time (minutes) | 0 to 30 | |
| Treatment water volume (L) | 3.6 | |
| Bromide ions (μg/L) | 50 | |
| Hydrogen peroxide concentration (mg/L) | 0.5 to 3.0 | |
| TOC (mg/L) | 2.0 | |
| Geosmin (ng/L) | 110 | |
| Electron-donating substance (μmol/L) | 0.03 to 300 | 0 |

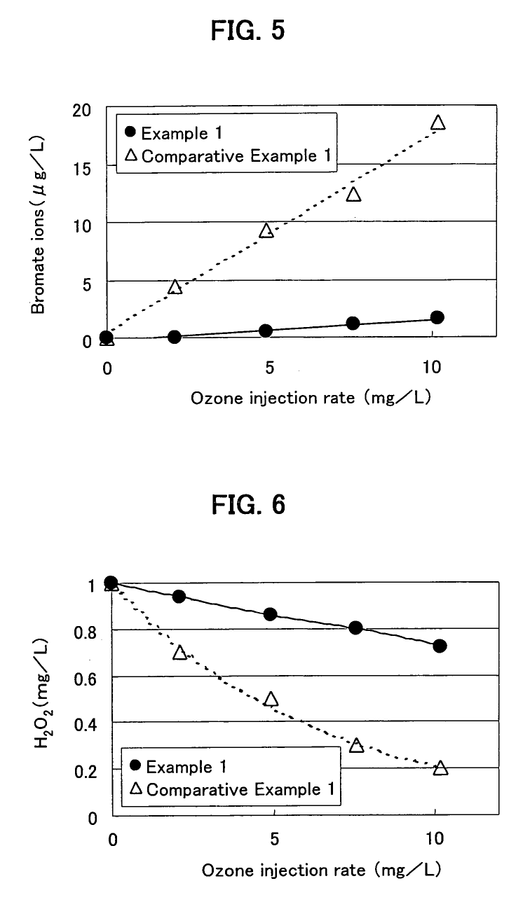

FIGS. 4, 5, and 6 show a change in geosmin concentration, a change in bromate ion production, and a change in hydrogen peroxide concentration with respect to ozone injection rate, respectively, in Example 1 and Comparative Example 1. This experiment was semi-batch type, that is, a vessel holding a certain volume of water was continuously aerated with the ozone gas. Horizontal axes of FIGS. 4 to 6 may each be regarded as accumulated amount of injected ozone or elapsed time. The figures reveal that injection of sucrose slightly decreased a geosmin decomposition rate than that of Comparative Example 1 but reduced the production of bromate ions and the consumption of hydrogen peroxide. In particular, the production of bromate ions significantly reduced from that of Comparative Example 1.

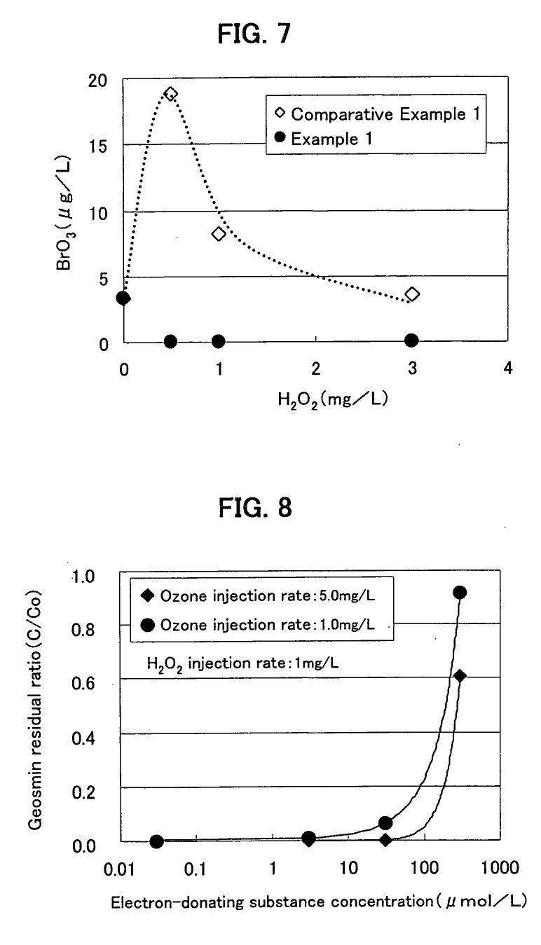

FIG. 7 shows a change in bromate ion production at varying hydrogen peroxide injection rates. The ozone injection rate was 5 mg/L. In a conventional treatment method described in Comparative Example 1, increase in hydrogen peroxide injection rate (H₂O₂/O₃=0.4 g/g or more) reduced the production of bromate ions. However, in Example 1, the production of bromate ions was suppressed even at a small hydrogen peroxide injection rate.

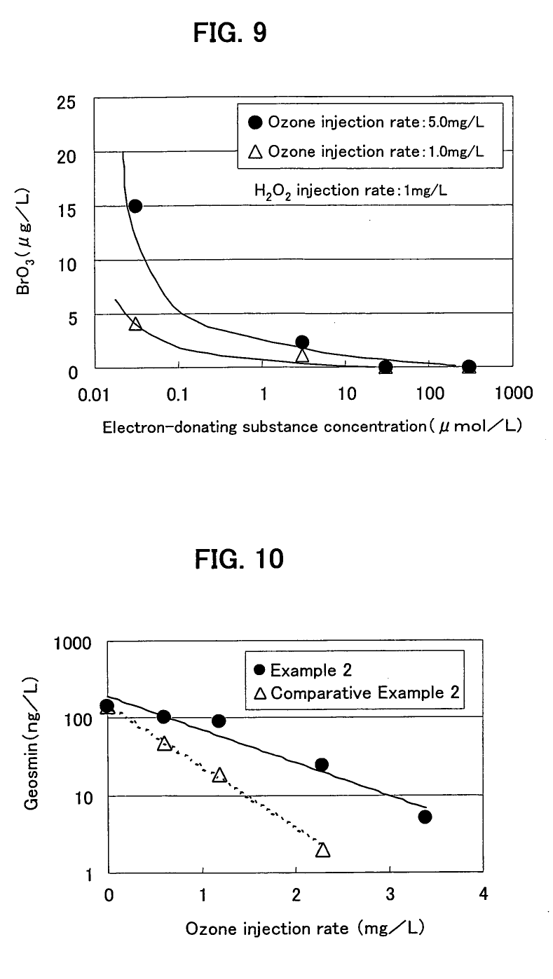

FIG. 8 shows a comparison of geosmin residual ratio at varying sucrose concentrations. The ozone injection ratio was 1 mg/L or 5 mg/L. Geosmin was particularly efficiently decomposed at a sucrose injection rate of 0.03 to 30 μmol/L. FIG. 9 shows a comparison of bromate ion production at varying sucrose concentrations. The production of bromate ions was suppressed to 10 μg/L or less at a sucrose injection rate of 0.1 μmol/L or more. The results revealed that the electron-donating substance was desirably injected within a concentration range of 0.1 to 30 μmol/L for decomposing geosmin to a standard value or less and suppressing the production of bromate ions at an ozone injection rate of 5 mg/L or less.

The results indicate that in the purification of water by using radicals, the radicals to be produced were maintained at a very low concentration by injecting sucrose as the electron-donating substance. Thus, geosmin was sufficiently decomposed while suppressing the production of bromate ions and the consumption of hydrogen peroxide to a large extent.

In Examples of the present invention, geosmin was used as a model substance for the low-degradable organic substance, but similar effects were obtained with 2-MIB, environmental hormones, and agricultural chemicals.

### Example 2 and Comparative Example 2

An example of experimental results of ozone/UV semi-batch treatment against a low-degradable organic substance in a pure water system will be described. Table 2 shows experimental conditions. In Example 2, geosmin was used as a model substance for the low-degradable organic substance, and 0.03 to 30 μmol/L of sucrose as an electron-donating substance was injected. In Comparative Example 2, geosmin was used as a model substance for the low-degradable organic substance, and an electron-donating substance was not injected in the same manner as in a conventional treatment method.

TABLE 2

| | | Comparative |
|---|---|---|
| | Example 2 | Example 2 |
| Ozone concentration (g/Nm³) | 5 | |
| Gas flow rate (L/min) | 0.25 | |
| Treatment time (minutes) | 0 to 30 | |
| Treatment water volume (L) | 3.6 | |
| Bromide ions (μg/L) | 50 | |
| Geosmin (ng/L) | 180 | |
| Electron-donating substance (μmol/L) | 0.03 to 300 | 0 |

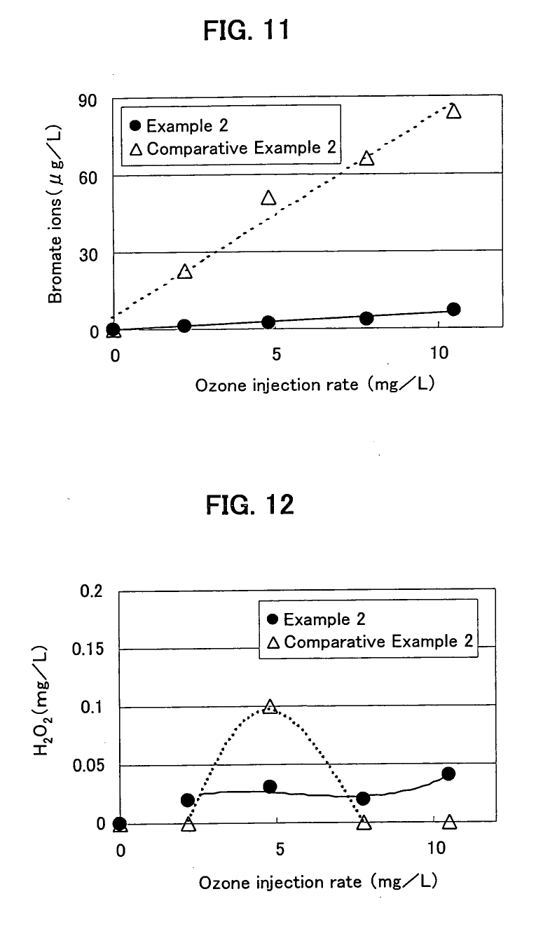

FIGS. 10, 11, and 12 show geosmin decomposition characteristics, bromate ion production characteristics, and a change in hydrogen peroxide concentration with respect to ozone injection rate, respectively, in Example 2 and Comparative Example 2. The figures revealed that injection of sucrose slightly decreased a geosmin decomposition rate with respect to the ozone injection rate than that of Comparative Example 2 but significantly reduced the production of bromate ions. Further, the results revealed that hydrogen peroxide was produced in the ozone/UV treatment process, and that the hydrogen peroxide production characteristics differed in Example 2 and Comparative Example 2.

The conventional ozone/UV treatment involves a treatment method in which ozone and radicals coexist, and the treatment method has no specific measure for suppressing the production of bromate ions. However, in the ozone/UV treatment process, an electron-donating substance was injected, to thereby allow suppression in production of bromate ions.

1. A water treatment method for purifying water by using radicals, comprising injecting into water an electron-donating substance selected from the group consisting of saccharides, amino acids, lipids, humic acids and mixtures thereof.

2. The water treatment method according to claim 1, includes producing the radicals using ozone in combination with hydrogen peroxide.

3. The water treatment method according to claim 1, including injecting the electron-donating substance into the water in a concentration of 0.1 μmol/L to 30 μmol/L.

4. A water treatment apparatus for purifying water by using radicals, comprising electron-donating substance injection means for injecting an electron-donating substance selected from the group consisting of saccharides, amino acids, lipids, humic acid, and mixtures thereof into water.
